(19) United States
(12) Patent Application Publication
(10) Pub. No.: US 2009/0001304 A1
(43) Pub. Date: Jan. 1, 2009

(54) System to Retrofit an Artificial Lift System in Wells and Methods of Use

(76) Inventors: Henning Hansen, Alicante (ES); Thomas G. Hill, JR., Conroe, TX (US)

Correspondence Address: RICHARD A. FAGIN, P.O. BOX 1247, RICHMOND, TX, 77406-1247, US

(21) Appl. No.: 12/143,867

(22) Filed: Jun. 23, 2008

Related U.S. Application Data
(60) Provisional application No. 60/947,223, filed on Jun. 29, 2007.

(51) Int. Cl. F16K 31/02

(52) U.S. Cl. 251/129.02

(57) ABSTRACT

Pump systems for installation in a wellbore and associated methods are disclosed. The pump system includes one or more internal safety valves that may include a closure mechanism, a biasing mechanism, and an actuator.

### CROSS-REFERENCE TO RELATED APPLICATIONS

Priority is claimed from U.S. Provisional Patent Application Ser. No. 60/947,223 filed on Jun. 27, 2007.

### STATEMENT REGARDING FEDERALLY SPONSORED RESEARCH OR DEVELOPMENT

Not Applicable

### BACKGROUND

1. Field of the Invention

The invention relates generally to the field of producing hydrocarbons from subterranean formations below the bottom of a body of water. More specifically, the invention relates to devices capable of providing isolation used to remove liquid from subsea wells.

2. Description of the Related Art

Subsurface valves are often installed in tubing strings between subterranean formations penetrated by wellbores to prevent the escape of fluid, to isolate one producing subsurface formation from another and to isolate the wellbore from the surface. Along with or as part of the subsurface valve, a subsurface safety valve is installed. Typically, the subsurface safety valve is installed in the upper part of the wellbore to provide rapid closure of the producing conduits should there be an emergency. Without a subsurface safety valve, a sudden increase in wellbore pressure can result in catastrophic blowouts of fluids into the ocean or atmosphere.

Two types of subsurface safety valve systems are known in the art: surface-controlled and subsurface controlled. Both types of safety-valve systems are designed to fail-safe so that the wellbore is isolated in the event of any blowout or damage to the surface production-control facilities. Many subsurface safety valves use a flapper-type valve for allowing substantially unrestricted flow when opened, but completely seal off flow when closed. A flapper-type valve typically includes a circular or curved valve disc to engage a valve seat. When engaged, the disc in combination with the valve seat is used to isolate the area above from the area below the flapper in the well. Flapper valve disks are often energized with a spring or hydraulic cylinder. When there is no actuating force applied, the valve remains closed. When the valve is closed, any build-up of pressure from the production zone below the valve will push the valve disc against the valve seat and will strengthen the sealing of the valve as a result. During normal use (as opposed to an emergency condition), the valve disk is kept opened by energizing the spring or hydraulic cylinder. Travel of various devices therethrough is unrestricted in such case.

Certain circumstances arise, for instance, when wells near the end of their productive life require some sort of artificial lift system to ensure sufficient production to remain economically useful. As an example, in gas wells, dewatering may be required to enable gas production to continue at acceptable rates. Such actions may also be required for other fluid producing wells and it may be necessary to be install a pump system downhole. Although the hydrocarbon-producing zone through which the well passes still has hydrocarbon reserves, in some cases the fluid pressure of the hydrocarbon-producing zone is insufficient to overcome the hydrostatic pressure or head of the fluid column in the wellbore. It may also be desirable to install a pump system downhole to periodically introduce particular chemicals into the wellbore to stimulate the production zone to increase the production of hydrocarbons.

In wells where a subsurface safety valve is utilized, a means to maintain a safe automatic well shut-in is required to replace the function of the downhole safety valve if the safety valve is disabled by a retrofit system installed into the existing production tubing. As described more fully below, it may be necessary to install piping or cables through an existing subsurface safety valve, partially or fully disabling the action of the subsurface safety valve. For instance, if subsurface safety valve system contains a flapper-type valve, the piping or cable passing therethrough may obstruct the flapper-type valve and not allow it to fully close.

There have been previous attempts to address similar problems. For instance, for so-called capillary string installations, insert safety valves have been developed. However, these insert safety valves are not suitable for installations where larger diameter equipment must pass through the subsurface safety valve, for example a spooled pipe with signal and power cables.

Accordingly, there exists a need for a relief system that enables fail-safe shut in of a well in which retrofit equipment is inserted through a previously installed subsurface safety valve.

### SUMMARY

A downhole pump system in one aspect of the invention includes a submersible pump within production tubing for enhancing the flow of fluid, a motor and an internal safety valve. The motor is operably connected to the submersible pump for driving the submersible pump. The internal safety valve is in fluid communication with the submersible pump and is configured to pass substantially all of the fluid capable of passing through the submersible pump. The internal safety valve includes a closure mechanism. The closure mechanism has an open position and a closed position, wherein the closure mechanism allows fluid flow through the internal safety valve when the closure mechanism is in the open position and substantially obstructs fluid flow through the internal safety valve when the closure mechanism is in the closed position. The internal safety valve further includes a biasing mechanism that is functionally connected to the closure mechanism. The biasing mechanism has an energized state and a non-energized state and is configured to move the closure mechanism to the open position when the biasing mechanism is in the energized state. The internal safety valve also includes an actuator. The actuator is configured to change the state of the biasing mechanism from the energized state to the non-energized state.

A method for removing liquid from a wellbore according to another aspect of the invention includes providing a downhole pump system. The downhole pump system includes a motor, a submersible pump mechanically connected to the motor, and an internal safety valve fluidly connected to the submersible pump. The internal safety valve includes a closure mechanism. The closure mechanism has an open position and a closed position wherein fluid flow is possible through the internal safety valve when the closure mechanism is in the open position. The fluid flow has a flow rate. The internal safety valve further includes a biasing mechanism. The biasing mechanism is designed to mechanically connect to the closure mechanism. The biasing mechanism has an energized and non-energized state, and the biasing mechanism is further designed to hold the closure mechanism in the open position when the biasing mechanism is in the energized state. The internal safety valve also includes an actuator, where the actuator is designed to change the state of the biasing mechanism from an energized to a non-energized state. The method further includes disposing the pump system in the production tubing of a wellbore, connecting an umbilical to the pump system, the umbilical having a pressure therein, energizing the biasing mechanism, and activating the pump system to remove liquid from the wellbore, the liquid having a liquid level, through the pump system.

Another example of a pump system for installation disposed in production tubing in a wellbore is disclosed which includes a generally cylindrical housing. The generally cylindrical housing has a circumference and extendable protuberances located along the circumference. The generally cylindrical housing is adapted to fit within a production tubing. The production tubing has landing nipples are disposed along the interior surface of the production tubing which are to receive the extendable protuberances. The pump system further includes an inlet port adapted to allow fluid to enter the generally cylindrical housing, a submersible pump within the generally cylindrical housing in fluid connection with the inlet port, a shaft, the shaft mechanically connected to the submersible pump, a motor, the motor mechanically connected to the shaft, and an internal safety valve. The internal safety valve is disposed within the generally cylindrical housing and is in fluid communication with the submersible pump. The internal safety includes a closure mechanism with an open position and a closed position, wherein fluid flow is possible through the internal safety valve when the closure mechanism is in the open position. The internal safety valve also includes a biasing mechanism designed to mechanically connect to the closure mechanism. The biasing mechanism has an energized and non-energized state and is further designed to hold the closure mechanism in the open position when the biasing mechanism is in the energized state. The internal safety valve also includes an actuator designed to change the state of the biasing mechanism from an energized to a non-energized state.

Other aspects and advantages of the invention will be apparent from the following description and the appended claims.

### BRIEF DESCRIPTION OF THE DRAWINGS

A more complete understanding of the present disclosure and possible advantages thereof may be acquired by referring to the following description taken in conjunction with the accompanying figures, wherein:

FIG. 1 shows a cross-sectional view of an artificial lift system installed in a subsea well in accordance with one embodiment of the present invention.

FIG. 2 shows a cross-sectional view of view of an umbilical.

FIG. 3 shows one embodiment of the artificial lift system shown in FIG. 1.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF PREFERRED EMBODIMENTS

The invention enables installation of equipment into existing wellbore tubing wherein it is desirable to maintain the function afforded by a downhole safety valve.

In certain examples, pump systems of the present invention comprise a motor, a submersible pump functionally connected to the motor; and an internal safety valve fluidly connected to the submersible pump. Internal safety valves of the present invention may comprise a closure mechanism wherein the closure mechanism has an open position and a closed position, a biasing mechanism operably connected to the closure mechanism. The biasing mechanism has an energized and a non-energized state wherein the biasing mechanism is adapted to motivate the closure mechanism to the open position when the biasing mechanism is in the energized state, and an actuator configured to change the state of the biasing mechanism from the energized state to a non-energized state.

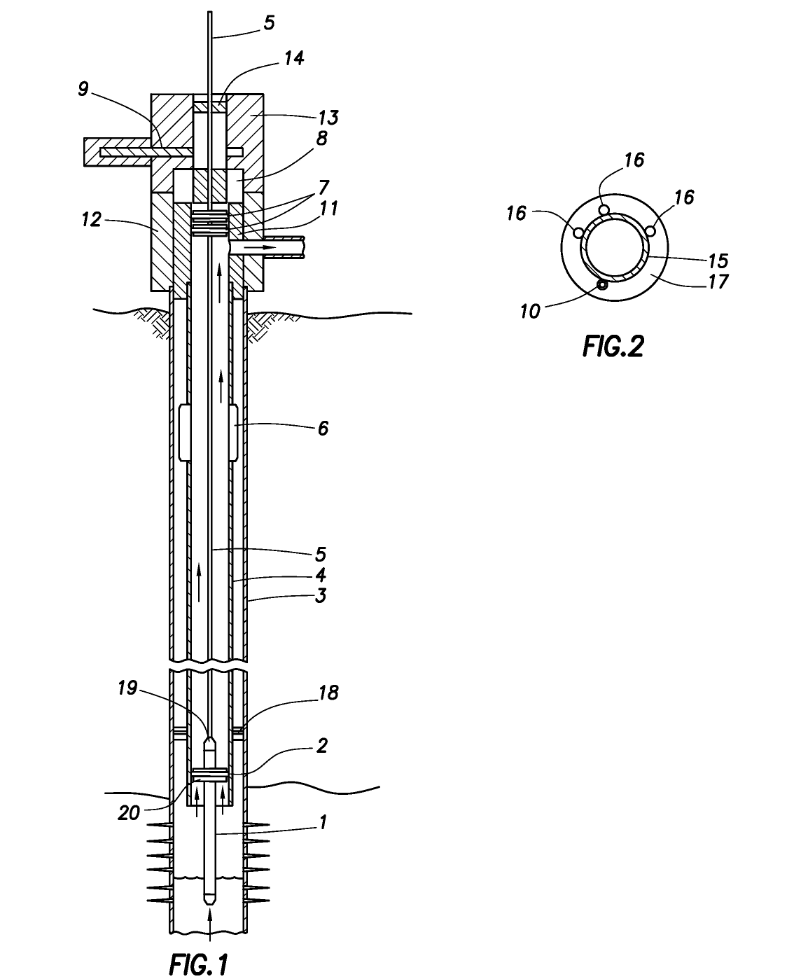

FIG. 1 illustrates a subsea well where an artificial lift system has been installed. The system includes production casing (3), a large-diameter pipe that has been lowered into an open hole and cemented in place. Disposed longitudinally within production casing (3) is production tubing (4), piping designed to communicate between hydrocarbon bearing portions of a formation and wellhead arrangement (12). Production packer (18) is shown to circumferentially encompass production tubing (4) and is designed to isolate the annulus between production casing (3) and production tubing (4) and anchor or secure the bottom of production tubing (4). A number of production packer designs are available as necessary depending on wellbore geometry and characteristics of the reservoir fluids. Subsurface safety valve (6) is disposed along production tubing (4) and operates as previously described herein. Subsurface safety valve (6) is most often disposed between production packer (18) and wellhead arrangement (12). Tubing hanger (11) is disposed in wellhead arrangement (12) and is attached to the topmost tubing joint in the wellhead to support production tubing (4). Any other necessary casing strings and tubulars normally installed in such a well not illustrated in FIG. 1 may be presumed to be included in the well depicted and are not shown only in order to simplify FIG. 1.

Pump system (1) is deployed within production tubing (4), typically near the bottom of production tubing (4) and most often below subsurface safety valve (6). Pump system (1) fluidly communicates with wellhead arrangement (12) through umbilical (5). Umbilical (5) connects to pump system (1) through connector (19). The umbilical (5) can also be of a solid type without an inner tube (15) for fluid transport. Such a design can be used where the fluids are produced out of the well in the annulus between umbilical (5) and production tubing (4).

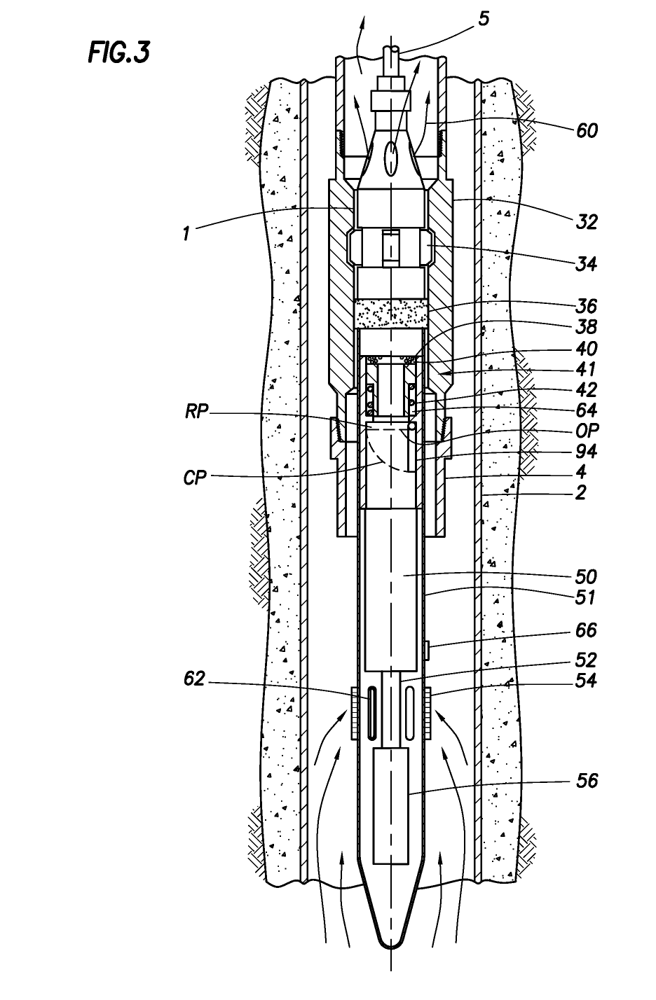

Another non-limiting type of umbilical (5) is shown in FIG. 2. The umbilical (5) depicted in FIG. 2 consists of inner tube (15) for fluid transport, one or more electrical conductors (16) to operate and monitor pump system (1) or any other downhole instrumentation as required. Electrical conductors (16) may also include one or more fiber optic cables to monitor downhole parameters and/or integrity of umbilical (5). Umbilical (5) depicted in FIG. 2 may further include one or more hydraulic tubes (10) for operating downhole hydraulic tools connected to the umbilical.

In wellhead system (12) or within tubing hanger (11) it may be necessary to mount one or more barriers (7). Umbilical (5) protrudes through the one or more barriers (7), which act to isolate fluids from within production tubing (4) from the surrounding environment by forming a seal between wellhead system (12) or tubing hanger (11). The type and composition of one or more barriers (7) depends on the geometry of wellhead system (12) and the production fluids themselves.

An additional sealing system (8) can be mounted in or on top of wellhead system (12) in much the same manner described for one or more barriers (7) designed to isolate fluids from exiting wellhead system (12) and entering the surrounding environment. Finally, a sealing and cutting system (13) may be mounted to the top of wellhead system (12). This sealing and cutting system incorporates a cutting system (9) as well as a seal (14) providing a seal against the umbilical (5).

FIG. 1 further depicts connector (19) at the top surface of pump system (1) although other arrangements are possible and the depicted connector (19) is not limiting. Connector (19) serves to fluidly, connect pump system (1) with umbilical (5). Umbilical (5) may also be connected to a seafloor located system (not illustrated) to provide power and/or control signals to pump system (1) as well as handling the water produced from the wellbore.

In one example of the present invention, pump system (1) includes an internally mounted safety valve (further illustrated below). The internally mounted safety valve is designed to automatically prevent fluid flow from travelling within umbilical (5) if hydraulic or electric power to pump system (1) is lost, such as from a control system mounted externally on wellhead system (12). In another example of the present invention, the internally mounted safety valve is a flow-operated valve that automatically closes if the fluid flow exceeds a preset maximum flow rate.

Pump system (1) is depicted as including external packing system (2) that fills the annulus between pump system (1) and production tubing (4) and seals against production tubing (4). As will be appreciated by one of ordinary skill in the art, the type of external packing system used, should one be necessary, depends on such factors as the type of pump system (1) employed and the nature of the production fluid, along with such other factors as bottomhole and pump system (1) geometries and operator preference.

In one example of the present invention, external sealing system (2) includes one or more flow ports (20). Flow ports (20) are ports that extend through the upper and lower surfaces of external sealing system (2). It is through these ports that gas may be produced from the formation through the production tubing. Flow ports (20) may include safety valves. The safety valves within flow ports (20) may be designed to work in much the same way as a subsurface safety valve, open during normal production operations and closed in the event of catastrophic failure or a desire to isolate wellhead system (12) from the hydrocarbon-producing formation (not shown).

The present example is related to a gas producing well, where water build-up in the wellbore proximate the reservoir (not shown) prevents or reduces the gas production. However, the system may also be used to lift fluids from a fluid well such as, for example, where the fluid pressure in the reservoir is not sufficient to lift the reservoir fluid to the wellhead system (12). For such an application, pump system (1) can pump the fluids into the annulus between the umbilical (5) and the production tubing (4), and in such applications flow ports (20), as well as any safety valves disposed therein, are optional and not required.

In an alternate installation, the system is installed safely into the well following a well kill operation, where dense fluids (or so called “kill pill” or heavy gel) are placed downhole. When the system has been installed, the dense fluids are pumped out of the well by pumping system (1).

In still another alternative installation method, a downhole check valve mechanism is installed in the wellbore such that that the pump assembly lands into the check valve when lowered into the wellbore. The check valve will be closed until the pump engages into the valve.

FIG. 3 schematically depicts in more detail one example of pump system (1) shown more generally in FIG. 1. In this particular example, pump system (1) includes a generally cylindrical housing (51) designed to fit longitudinally within production tubing (4). Pump system (1) is so configured as to allow fluid to enter through one or more inlet ports (54) and exit through one or more outlet ports (60). Inlet ports (54) may include sand exclusion devices (62); the most typical sand exclusion device to be used would be screens to reduce the amount of sand and other non-fluid material from possibly being entrained with the fluid as it enters pump system (1). In another example of the present invention, outlet ports (60) are not present and fluid exits through umbilical (5). Pump system (1) may be lowered into the wellbore inside production tubing (4) with umbilical (5). Umbilical (5) can include any combination of electric power transmission lines, hydraulic control lines, tensile load members (such as cables), fluid export conduit, and a flexible or resilient covering.

Also depicted in the example shown in FIG.3 is seal (36). Seal (36) is adapted to provide a seal between pump system (1) and production tubing (4). Seal (36) is located along the outer circumference of generally cylindrical housing (51); its composition is generally dependent upon the type of fluids within production tubing (4), as well as the general geometry of the wellbore.

In the example shown in FIG. 3, pump system (1) includes one or more locking devices (34). Locking devices (34) are typically extendable protuberances located along the circumference of pump system (1). Locking devices (34) are designed to “catch” or fit within one or more landing nipples (32) located along the inner wall of production tubing (4). Landing nipples (32) are designed to restrict movement of pump system (1) when locking devices (34) are disposed therewithin. Various designs of both locking devices (34) and landing nipples (32) are familiar to those of ordinary skill in the art and are not meant to be limiting of the present invention.

The example of pump system (1) shown in FIG. 3 further includes motor (56), submersible pump (50), and internal safety valve (41). Motor 56 is disposed within pump system (1) and is any one of a number of motors for use in downhole service. Motor (56) is functionally connected to submersible pump (50) through drive shaft (62), although other connections, such as magnetic couplings, can be used to functionally coupled the motor (56) to the pump (50). When operated, motor (56) turns drive shaft (52), and operate submersible pump (50). The impeller of submersible pump (50) moves fluid from inlet ports (54) through submersible pump (50) and out outlet ports (60) or through umbilical (5). Submersible pump (50) may also be any suitable positive displacement pump including, but not limited to, a rod pump. Further disposed within cylindrical housing (51) is internal safety valve (41). Internal safety valve (41) is located between fluid outlet ports (60) and submersible pump (50) and is in fluid communication with both. In the example shown in FIG. 3, substantially all fluid that passes through pump system (1) passes through internal safety valve (41). Internal safety valve (41) is further disposed within conduit (64). Conduit (64) is in fluid communication with submersible pump (50) and is capable of transporting substantially all of the fluid flow from submersible pump (50). Internal safety valve (41) further includes closure mechanism (44), biasing mechanism (42), and actuator (40).

Closure mechanism (44) shown is a flapper valve and has an open and a closed position. Non-limiting examples of a flapper closure can be found in U.S. Pat. No. 7,360,600 filed Dec. 21, 2005 entitled “Subsurface Safety Valve,” and U.S. Pat. No. 5,862,864 filed Jan. 26, 1999 entitled “Well Safety System.” Note that a ball closure or poppet closure, both well known devices to those of ordinary skill in the art, may also be used as closure mechanism (44). A non-limiting example of each may be found, respectively, in U.S. Pat. No. 4,708,163 filed Jan. 28, 1987 entitled “Safety Valve” and U.S. Pat. No. 4,448,216 filed Mar. 15, 1982 entitled “Subsurface Safety Valve.” When in the open position (as shown in FIG. 3), closure mechanism (44) allows passage of fluid between one or more inlet ports (54) and one or more outlet ports (60). Closure mechanism (44) is held in the open position by biasing mechanism (42). Biasing mechanism (42) is typically at least one spring, which biases the valve to the closed position. Coil springs, wave springs or leaf springs are all springs may be used effectively in this application. Alternatively, a chamber pressurized with a gas charge may be utilized as a biasing mechanism to urge the valve to the closed position. Actuator (40) as shown is an electric coil. When electrically excited or energized, actuator (40) opens closure mechanism (44). Removing power from the coil, removes the energy from biasing mechanism (42), thus allowing closure mechanism (44) to move to the closed position (as shown by closure path CP) in FIG. 3) and allows internal safety valve (41) to close, preventing the flow of fluids from one or more inlet ports (54) through one or more outlet ports (60) or through umbilical (5). Actuator (40) may also be a hydraulic actuator, where application

In the example depicted in FIG. 3, internal safety valve (41) further includes shiftable sleeve (38). When closure mechanism (44) is in the open position, shiftable sleeve (38) is held in open position (OP), as indicated on FIG. 3, preventing actuator (40) from urging closure mechanism (44) to its closed position. Shiftable sleeve (38) is axially moveable along generally cylindrical housing (51) to retracted position (RP), permitting closure means to move to its closed position upon activation of actuator (40).

Actuator (40) may be operated by any number of typical means, including remote, manual, and automatic activation. For instance, actuator (40) may be operated from the surface, such as by an operator who desires to stop fluid flow from passing through pump system (1). However, it may be desirable to stop fluid flow from passing through submersible pump (50) due to conditions of pump system (1). For this reason, conditions of pump system (1) may be monitored by sensors (66) that measure various parameters of pump system (1). In various examples of the present invention, sensors (66) may monitor the rate or volume of fluid flow through pump system (1), or the liquid levels within the wellbore. In the event of low or no flow through pump system (1) or high or low liquid levels within the wellbore, actuator (40) may be operated to prevent damage to pump system (1). In some examples of the present invention of pump system (1), a preset upper and/or lower liquid level limit may be established. Then, when the liquid level within the wellbore reaches the upper limit, actuator (40) may be energized, allowing biasing mechanism (42) to hold closure mechanism (44) in the open position and allow fluid flow through pump system (1). Conversely, when the liquid level within the wellbore reaches a pre-set lower limit, actuator (40) may be de-energized, so as to cause biasing mechanism (42) to allow closure mechanism (44) to the closed position and substantially restricting flow through pump system (1). In other various examples of the present invention, sensors (66) may monitor umbilical (5) to determine pressure or breakage of umbilical (5) and operate actuator (40) to de-energize biasing mechanism (42) when umbilical (5) breaks or reaches a certain pre-set high pressure.

The examples disclosed herein have generally been described in the context of a subsea installation. One of ordinary skill in the art with the benefit of this disclosure will appreciate that examples of the present invention would be suitable for surface or land-based installation as well. Additionally, it is explicitly recognized that any of the features and elements of the examples disclosed herein may be combined with or used in conjunction with any of the other examples disclosed herein.

Therefore, the present invention is well adapted to attain the ends and advantages mentioned as well as those that are inherent therein. The particular examples disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A downhole pump system comprising:
a submersible pump disposed within a production tubing;
a motor operably connected to the submersible pump; and
an internal safety valve in fluid communication with the submersible pump, the internal safety valve including:
a closure mechanism having an open position and a closed position, the closure mechanism enabling fluid flow through the internal safety valve when the closure mechanism is in the open position and wherein the closure mechanism substantially obstructs fluid flow through the internal safety valve when the closure mechanism is in the closed position;
a biasing mechanism functionally connected to the closure mechanism, the biasing mechanism having an energized state and a non-energized state wherein the biasing mechanism is configured to move the closure mechanism to the open position when the biasing mechanism is in the energized state; and
an actuator configured to change the state of the biasing mechanism from the energized state to the non-energized state.

2. The downhole pump system of claim 1, wherein the closure mechanism is at least one of a flapper, ball, and poppet closure.

3. The downhole pump system of claim 1, wherein the pump system further comprises an umbilical and a connection for the umbilical wherein the umbilical is fluidly or electrically connected to the submersible pump.

4. The downhole pump system of claim 1, wherein the biasing mechanism is a spring or a chamber pressurized with a gas charge.

5. The downhole pump system of claim 4, wherein the biasing mechanism is a spring and the spring is a coil spring, a leaf spring, or a wave spring.

6. The downhole pump system of claim 1, wherein the actuator is an electric coil or a hydraulic actuator.

7. The downhole pump system of claim 1 further comprising a conduit in fluid communication with the submersible pump wherein the internal safety valve is disposed in the conduit.

8. The downhole pump system of claim 1 further comprising an external packing disposed about the submersible pump wherein the external packing comprises one or more fluid ports adapted to pass gas through the one or more fluid ports.

9. The downhole pump system of claim 7 further comprising a shiftable sleeve, the shiftable sleeve disposed within the conduit, wherein the shiftable sleeve has a shiftable sleeve open position and a shiftable sleeve retracted position, and further wherein the shiftable sleeve is adapted to prevent the closure mechanism from attaining the closed position when the shiftable sleeve is in the shiftable sleeve open position and allowing the closure mechanism to attain the closed position when the shiftable sleeve is in the shiftable sleeve retracted position.

10. A method for removing liquid from a wellbore, the method comprising:
a. providing a downhole pump system comprising a motor, a submersible pump mechanically connected to the motor, and an internal safety valve fluidly connected to the submersible pump wherein the internal safety valve includes a closure mechanism, the closure mechanism having an open position and a closed position wherein fluid flow is possible through the internal safety valve when the closure mechanism is in the open position, the fluid flow having a flow rate, a biasing mechanism, the biasing mechanism designed to mechanically connect to the closure mechanism, the biasing mechanism having an energized and non-energized state, and the biasing mechanism being further designed to hold the closure mechanism in the open position when the biasing mechanism is in the energized state, and an actuator, the actuator designed to change the state of the biasing mechanism from an energized to a non-energized state;
b. disposing the pump system in a production tubing;
c. connecting an umbilical to the pump system, the umbilical having a pressure therein;
d. energizing the biasing mechanism; and
e. activating the pump system to remove liquid from the wellbore, the liquid having a liquid level, through the pump system.

11. The method of claim 10 further comprising:
monitoring the liquid level; and
establishing a pre-set maximum limit for the liquid level and performing step (d) when the liquid level reaches the pre-set maximum limit.

12. The method of claim 10 further comprising:
monitoring the liquid level;
establishing a pre-set minimum limit for the liquid level; and
de-energizing the biasing mechanism when the liquid reaches the pre-set minimum limit.

13. The method of claim 10 further comprising:
monitoring fluid flow;
establishing a pre-set minimum for fluid flow; and
de-energizing the biasing mechanism when fluid flow reaches the pre-set minimum.

14. The method of claim 10 further comprising:
monitoring the pressure of the umbilical;
establishing a pre-set maximum limit for the pressure of the umbilical; and
de-energizing the biasing mechanism when the pressure of the umbilical reaches the pre-set maximum limit.

15. The method of claim 10 further comprising de-energizing the biasing mechanism in the event of umbilical breakage.

16. The method of claim 10 wherein the umbilical is adapted to transport liquid and further comprising transporting liquid through the umbilical.

17. A pump system for installation in a wellbore, the pump system disposed within a production tubing, comprising:
a generally cylindrical housing, the generally cylindrical housing having a circumference and extendable protuberances located along the circumference, and the generally cylindrical housing adapted to fit longitudinally within a production tubing, the production tubing having an interior surface and a plurality of landing nipples, the landing nipples disposed along the interior surface of the production tubing and adapted to receive the extendable protuberances;
an inlet port adapted to allow fluid to enter the generally cylindrical housing;
a submersible pump within the generally cylindrical housing in fluid connection with the inlet port;
a shaft, the shaft mechanically connected to the submersible pump;
a motor, the motor mechanically connected to the shaft;
an internal safety valve, the internal safety valve disposed within the generally cylindrical housing and in fluid communication with the submersible pump, the internal safety including a closure mechanism, the closure mechanism having an open position and a closed position, wherein fluid flow is possible through the internal safety valve when the closure mechanism is in the open position, a biasing mechanism, the biasing mechanism designed to mechanically connect to the closure mechanism, the biasing mechanism having an energized and non-energized state, and the biasing mechanism being further designed to hold the closure mechanism in the open position when the biasing mechanism is in the energized state, and an actuator, the actuator designed to change the state of the biasing mechanism from an energized to a non-energized state.

18. The pump system of claim 17, wherein the pump system further comprises an outlet port, the outlet port in fluid communication with the internal safety valve and adapted to allow fluid to exit the generally cylindrical housing.

19. The pump system of claim 17, wherein the pump system further comprises a sand exclusion device, the sand exclusion devices disposed within the inlet port and adapted to exclude particulate matter from entering the generally cylindrical housing.

20. The pump system of claim 19, wherein the sand exclusion device is a sand screen.

21. The pump system of claim 17, wherein the pump system further comprises a connection for an umbilical, the connection for the umbilical being fluidly connected with the internal safety valve and adapted to allow fluid to pass from the generally cylindrical housing to an umbilical.
